(19) United States
(12) Patent Application Publication
(10) Pub. No.: US 2009/0325588 A1
(43) Pub. Date: Dec. 31, 2009

(54) Data transmission in cellular phone network

(75) Inventor: Guillaume Delaval, Berkshire (GB)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC CORPORATION, TOKYO (JP)

(21) Appl. No.: 12/311,214

(22) PCT Filed: Sep. 19, 2007
(86) PCT No.: PCT/JP2007/068739

§ 371 Date: Mar. 23, 2009

(30) Foreign Application Priority Data
Sep. 26, 2006 (GB) 0618928.6

(51) Int. Cl. H04W 72/00; H04B 7/00

(52) U.S. Cl. 455/452.1; 455/522

(57) ABSTRACT

The invention provides for a method of transmitting data in a mobile radio communications network cell, wherein at least one data block is transmitted, at a first transmission power level, for a user of the cell, the method including the step of monitoring radio resource occupancy within the cell and at least duplicating the said at least one data block within the cell responsive to a determination that the radio resource occupancy has reduced to a level below a threshold value, and whereby the duplicated data blocks are transmitted at a second transmission power level less than the said first transmission power level.

The present invention relates to data transmission within a cellular phone network and, in particular, to a method of transmitting data in a mobile radio communications network cell and to related data transmitter.

Within a mobile radio communications network, and in particular within a network employing Orthogonal Frequency Division Multiplexing (OFDM), it is common for different cells to share the same frequency bandwidth, which scenario can lead to interference between the different cells. Such inter-cell interference can arise in particular in relation to OFDM based systems since, unlike WCDMA systems in which a single radio link is likely to employ the entire cell bandwidth, total bandwidth occupancy within OFDM based systems tends to depend upon cell load. In view of this, it is most likely that the power spectrum across the cell bandwidth will not be uniform since, across that spectrum, several frequencies are likely to exhibit a first transmission power level, other frequencies may exhibit a second transmission power level different from the first, and further frequencies may be completely unused. Thus, for two cells sharing the same bandwidth, this can potentially result in a high degree of inter-cell interference for some sections of the power spectrum, whilst no interference will be experienced by other sections.

Such potential for interference can prove particularly disadvantageous and limiting and the present invention seeks to provide for a data transmitter for a mobile radio communications network cell, and related method of transmitting data within such a cell, which exhibits advantages over known such transmitters and methods.

According to a first aspect of the present invention there is provided a method of transmitting data in a mobile radio communications network cell, wherein at least one data block is transmitted, at a first transmission power level, for a user of the cell, the method including the step of monitoring radio resource occupancy within the cell and at least duplicating the said at least one data block within the cell responsive to a determination that the radio resource occupancy has reduced to a level below a threshold value, and whereby the duplicated data blocks are transmitted at a second transmission power level less than the said first transmission power level.

The invention proves advantageous in view of the potential for dynamic alteration of the transmission power level within the cell such that, when radio resource occupancy across the cell bandwidth dictates it to be appropriate, transmission power level employed by at various of the frequencies across the cell bandwidth can be reduced thereby decreasing the potential for inter-cell interference.

Although the power level for a signal transmitted within the cell is reduced, the likelihood of accurate reception of such signals is not correspondingly reduced in view of the duplication noted above and as described further.

In one particular embodiment, the said at least one data block comprises an OFDM resource block.

Further, the said at least duplication of the data block includes the step of generating different versions of the said data block.

Advantageously, the different versions can comprise different versions of the said data blocks employing different coding schemes and/or modulation schemes.

In particular, different puncturing and/or repetition methods can be employed so as to create the different versions when duplicating the said at least one data block.

In one particular embodiment, the step of duplicating the at least one data block is based upon a HARQ repetition scheme but with the repeated data blocks transmitted in parallel.

Thus, as should be appreciated, the duplication of the said at least one data block can lead to the creation of different OFDM resource blocks. The different OFDM resource blocks can comprise physical resource blocks each having a number of sub-carriers allocated for different periods of time.

Further, the step of monitoring the radio resource occupancy can include the step of determining the number of physical resource blocks that are in use across the cell bandwidth at any one time.

Advantageously, the method can further include the step of returning to transmission at the said first transmission power level if it is determined that the radio resource occupancy has increased to a level above the said threshold value.

As will be appreciated from the detailed discussion further below, and as mentioned above, although the said second transmission power level is less than the said first level, the detection probability can nevertheless be retained in view of the employment of several versions of a given data block due, in particular, to the coding and frequency diversity that can be achieved by way of the data block duplication.

Transmission power level within the transmitter can therefore be reduced without any disadvantageous effect on detection probability and this of course forms the basis for a reduction in inter-cell interference.

According to another aspect of the present invention there is provided a data transmitter for a mobile radio communications cellular network and which is arranged to transmit, at a first transmission power level, at least one data block, the transmitter including monitoring means for monitoring radio resource occupancy within a cell, duplicating means for at least duplicating the data block within the cell and responsive to a determination that the radio resource occupancy has reduced to a level below a threshold value, and the transmitter being arranged to transmit the duplicated data blocks at a second transmission power level less than the first transmission power level.

As will be appreciated, such a data transmitter is arranged to operate in accordance with the method defined above and therefore exhibits similar advantages thereto.

For example, the data transmitter can be arranged to transmit data blocks in the form of resource blocks.

Also, the duplicating means can be arranged to generate different versions of a data block, the different versions can be differentiated by different coding schemes and/or modulation schemes and, in particular, by means of different puncturing and/or repetition methods.

In particular, the data transmitter can be arranged to create duplicated data blocks on the basis of a HARQ scheme. Further, the means for duplicating can be arranged to create different OFDM resource blocks.

Again, the said monitoring means can be arranged to identify the number of physical resource blocks in use at any one time.

As with the method noted above, the data transmitter can be arranged to return to transmission at the said first power level if it is determined within the monitoring means at the radio resource occupancy has increased above the said threshold value.

In particular, the said monitoring means and the duplicating means can comprise a scheduler for determining the duplication factor to be applied to the data block.

In one particular embodiment, the said data transmitter comprises a base station and/or an eNodeB transmitter.

As will therefore be appreciated from the above, the present invention can prove advantageous insofar as it effectively serves to spread the potential inter-cell interference over the entire cell bandwidth in an attempt to arrive at acceptable signal-to-interference ratios for each of the OFDM resource blocks transmitted across the cell bandwidth.

The invention is described further hereinafter, by way of example only, with reference to the accompanying drawings in which:

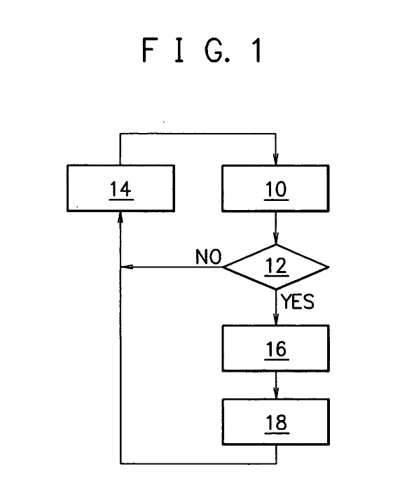

FIG. 1 is a flow diagram representing an algorithm in accordance with which an embodiment of the present invention can be implemented;

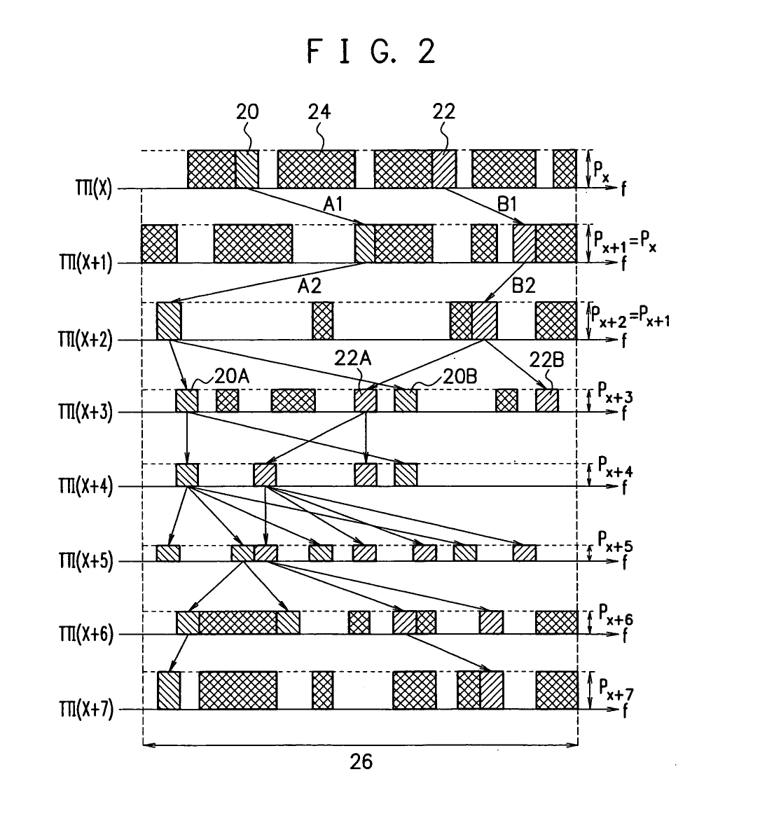

FIG. 2 is a timing diagram for transmission within a cell of a mobile radio communications network in accordance with an embodiment of the present invention;

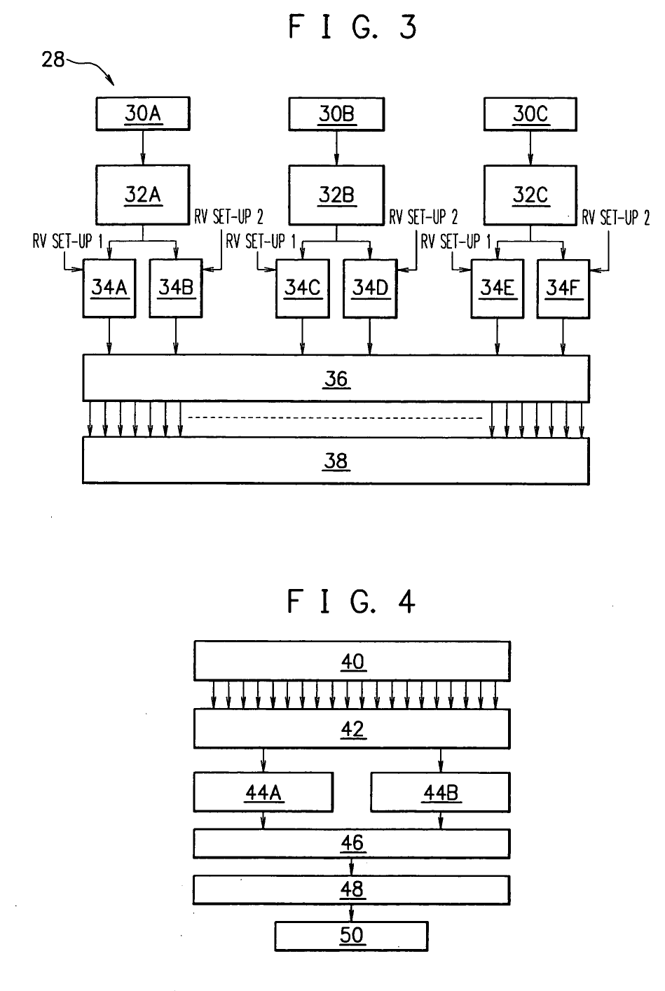

FIG. 3 is a block diagram of an eNodeB transmitter embodying the present invention; and

FIG. 4 is a schematic block diagram of a mobile radio communications device arranged for use in accordance with a method and transmitter embodying the present invention.

With regard to the accompanying drawings, it should be appreciated that the illustrated embodiment of the present invention relates to the transmission of OFDM resource blocks and in which duplication of the resource blocks is based upon known Hybrid ARQ schemes.

The primary aspects of a method employing the present invention are illustrated in FIG. 1 and which commences at 10 with a determination of the radio resource allocation within a particular cell of a mobile radio communications network. As will be appreciated from the discussion that follows, the physical resource allocation within the cell is generally surveyed by way of a determination of the number of OFDM physical resource blocks that are in use at any particular time.

At step 12, a determination of whether or not the block duplication of the present invention should be activated is made; any such duplication being based upon the HARQ techniques and identified here as Duplicated-HARQ (D-HARQ).

Traditional HARQ schemes send data blocks one after the other for each HARQ process. If one block has not been correctly decoded on the Tx side, the receiver sends a request to the transmitter for the data block to be re-emitted using a different redundancy version (i.e. incremental redundancy) or using exactly the same bits that have been already transmitted (i.e. chase combining). The receiver will then combine the different version of the data block before channel decoding. A CRC field may help then to know whether the data block has been correctly decoded or not.

Thus, at step 12, if it is determined that the resource allocation has not decreased to an extent sufficient to activate the D-HARQ of the present invention, the procedure merely returns to repeat the survey of the resource allocation step 10 via step 14 in which scheduling information can be updated if required.

If, however, at step 12 it is determined that radio resource allocation has reduced to below the threshold value, D-HARQ is activated so as to introduce resource block duplication at step 16 and a related scaling-down of the transmission power for the duplicated blocks at step 18.

As will be appreciated from the following discussion, the degree of scaling-down of the transmission power for the duplicated resource block can itself be related directly to radio resource occupancy within the cell such that a variety of reduced power levels will be available.

Turning now to FIG. 2, there is provided a timing diagram illustrating the manner in which radio resource occupancy across the bandwidth of a single cell can vary with time and how, depending upon such variation, the transmission power of the remaining duplicated resource blocks can be varied so as to provide for the advantages of the present invention.

Throughout the timing diagram of FIG. 2, there are illustrated resource blocks 20, 22 allocated to first and second users respectively, and remaining resource blocks 24, allocated to a variety of other users.

As the transmission timing proceeds, it will be appreciated that the resource blocks 20-24 allocated to different users shift within the bandwidth 26 of the cell as illustrated in relation to the resource blocks 20, 22, by arrows A1, B1; A2, B2.

At the first two time periods, it is will be seen that the radio resource allocation generally remain constant in view of the occupancy provided by the resource blocks 24 allocated to other users.

However, at the third timing point TTI (X+2) it will be noted that the occupancy provided by the resource blocks allocated to such other users has decreased.

In the illustrated example, such decrease brings the radio resource occupancy to a level below a predetermined threshold value such that, in accordance with the invention, it is now determined that D-HARQ can be activated. This serves to duplicate the resource blocks 20, 22 of the first and second users and, likewise, to reduce the transmission power level as indicated at time period TTI (X+3).

It will be appreciated that each of the resource blocks 20, 22 has been duplicated to provide different versions of the resource block as illustrated as 20A, 20B; 22A, 22B.

Within the illustrated example, and with particular reference to timing period TTI (X+4), it will be appreciated that the radio resource occupancy has decreased yet further insofar as no occupancy arises in relation to the resource blocks 24 allocated to other users.

In accordance with the illustrated embodiment of the present invention therefore, further duplication of the original resource blocks 20, 22 of the first and second users can occur such that, as illustrated at time period TTI (X+5) the cell bandwidth 26 includes four resource blocks per user such that a duplication factor of four has been applied.

Again, and as will be appreciated in comparison with time periods TTI (X+4) and TTI (X+5) the transmission power for each resource block is yet further reduced.

The transmission at reduced power level, and with the illustrated degree of duplication, can continue until such time as it is determined that the radio resource occupancy begins to increase again. Such increase will be determined particularly by the appearance of resource blocks allocated to other users and such as illustrated at timing intervals TTI (X+6) and TTI (X+7).

Indeed, within the illustrated embodiment, it will be appreciated that the radio resource occupancy due to the resource blocks allocated to other users returns, at period TTI (X+7) to a level above the threshold value so that the D-HARQ of the present invention is no longer initiated.

With regard to FIG. 2 it should be appreciated that this illustrated example is based upon an assumption that the allocated frequencies for a given resource block are localised and that a given single physical resource block is allocated to a single user and not shared when D-HARQ is not activated.

The accurate implementation of the present invention generally requires a scheduling mechanism provided within the data transmitter and which takes on responsibility for allocating physical resources to different users within the cellular network. Advantageously however, the complexity of the encoding chain for the physical resources is only increased a small degree within the invention and actual channelling coding and decoding can remain unchanged. The arrangement however within the transmitter for rate matching, for example puncturing and repetition operations, is generally arranged to generate required duplicated blocks of data.

Turning to FIG. 3, there is illustrated a schematic block diagram of an eNodeB transmitter 28 according to an embodiment of the present invention and which is arranged to employ a D-HARQ duplication factor of two.

A transmitter 28 is illustrated for use in relation to a plurality of users each of which delivers a respective block of data 30A, 30B, 30C to a respective channelling encoder 32A, 32B, 32C. However as mentioned, a duplication factor of two is applied in accordance with the eNodeB transmitter 28 illustrated in FIG. 3 and so each of the respective channelling encoders 32A, 32B, and 32C feeds to a respective pair of D-HARQ duplication units 34A, 34B; 34C, 34D; 34E, 34F.

Once duplicated, the data blocks are delivered to a multiplexing and symbol mapping arrangement 36 for onward delivery to the OFDM transmitter 38 for providing the output of the eNodeB transmitter 28.

The reduce power transmission of the duplicated data blocks delivered from the OFDM transmitter 38 when the particular radio resource occupancy threshold level has been surpassed allows for transmission of data from the eNodeB transmitter 28 in a manner that exhibits a reduced likelihood of experiencing/generating interference with regard to other cells within the network.

To complete the illustration of the present invention reference is now made to FIG. 4 which is a schematic block diagram of a mobile radio communications device arranged for communicating with, for example, an eNodeB transmitter 28 such as that illustrated in FIG. 3.

The device of FIG. 4 comprises an OFDM receiver arrangement 40, related multiplexing and complexing and symbol mapping 42 which, in accordance with the above aforementioned duplication factor of two, is arranged to feed to duplicated D-HARQ processing means 44A, 44B, each of which provides an output to combining and HARQ memory management module 46 which is arranged to provide a signal input to a channel decoder 48 so as to arrive at the required block of data 50 at the mobile radio communications device.

As will therefore be appreciated from the above, the present invention advantageously improves traditional Hybrid ARQ schemes using the specificity of OFDMA multiple access in a manner serving to reduce inter-cell interference. Several versions of given data blocks are sent simultaneously using different puncturing/repetition methods. While this advantageously increases the detection probability on the receiver side due to coding and frequency diversity, it also allows the transmitter to reduce its transmission power so as to achieve a reduction of inter-cell interference by way of improved spectrum allocation between users.

At the transmitter side i.e. the base station or eNodeB transmitter as illustrated in FIG. 3, a scheduler can be arranged to track the radio resource occupancy, and mainly how many OFDM physical resource block are in use at a given time.

For a given user involved in data transmission, the blocks of user's data will be sent in parallel using different OFDM resources blocks, i.e. physical resource blocks composed by a number of sub-carriers allocated for a defined time period, and using different puncturing/repetition schemes. The duplication rate will be decided by the scheduler. The invention proposes a duplication rate as a data block duplication factor determined by the cell scheduler either for a given user, a portion of users or all the users present in a cell. It should also be appreciated that, in addition, a traditional HARQ scheme can be used for serial data block repeats.

Based on the scheduler decision, the Tx power allocated for each physical resource blocks that is using the duplication method is scaled down and so the overall Tx power will be better distributed over the cell bandwidth. This will result in a “whiter” spectra and inter-cell interference effects will be mitigated for cells sharing the same frequency band.

In one arrangement, the mechanism of the invention can be added to the scheduling algorithm based on measurement reports from the UE as well as on interference coordination methods.

Thus, in conclusion, it should be appreciated that the invention can provide for a system generating different versions of the same block of encoded data based on HARQ well known schemes and that is able to transmit different versions at the same time.

Primarily the system is capable of transmitting simultaneously different versions of the same encoded block based on the cell load or on the basis of already existing schemes.

It can also be readily determined which of a plurality of users are employing the invention, and to provide for a system that is capable of maximising the number of users using D-HARQ.

1. A method of transmitting data in a mobile radio communications network cell, wherein at least one data block is transmitted, at a first transmission power level, for a user of the cell, the method including:
monitoring radio resource occupancy within the cell and at least duplicating said at least one data block within the cell responsive to a determination that the radio resource occupancy has reduced to a level below a threshold value, and whereby the duplicated data blocks are transmitted at a second transmission power level less than the said first transmission power level.

2. A method as claimed in claim 1, wherein said at least one data block comprises an OFDM resource block.

3. A method as claimed in claim 1, wherein said at least duplication of at least one of the data blocks includes generating different versions of said data block.

4. A method as claimed in claim 3, wherein said different versions comprise duplications of said data block employing at least one of different coding schemes and modulation schemes.

5. A method as claimed in claim 1, wherein the duplicating the at least one data block is based upon a HARQ repetition scheme, with the repeated data blocks being transmitted in parallel.

6. A method as claimed in claim 1, wherein the duplication of said at least one data blocks leads to the creation of different OFDM resource blocks.

7. A method as claimed in claim 1 wherein the monitoring the radio resource occupancy includes determining a number of physical resource blocks that are in use across the cell bandwidth.

8. A method as claimed in claim 1, further including returning to transmission at said first transmission power level if it is determined that the radio resource occupancy has increased to a level above said threshold value.

9. A method as claimed in claim 1, further including selecting data blocks from a plurality of data blocks for the at least duplication.

10. A method as claimed in claim 1, wherein a selected one or more of the duplicates is itself at least duplicated at a yet further decreased transmission power level.

11. A data transmitter for a mobile radio communications cellular network and which is arranged to transmit, at a first transmission power level, at least one data block, the transmitter including:
a monitoring unit that monitors radio resource occupancy within a cell; and
a duplicating unit that at least duplicates the data block within the cell and responsive to a determination that the radio resource occupancy has reduced to a level below a threshold value, the transmitter being arranged to transmit the duplicated data blocks at a second transmission power level less than the first transmission power level.

12. A data transmitter as claimed in claim 11 and arranged to transmit data blocks in the form of resource blocks.

13. A data transmitter as claimed in claim 11, wherein the duplicating unit is arranged to generate different versions of a data block.

14. A data transmitter as claimed in claim 13, wherein the different versions are differentiated by at least one of different coding schemes and modulation schemes.

15. A data transmitter as claimed in claim 11, wherein the data transmitter is arranged to create duplicated data blocks on a basis of a HARQ scheme.

16. A data transmitter as claimed in claim 11, wherein the duplicating unit that duplicates is arranged to create a different OFDM resource block.

17. A data transmitter as claimed in claim 11, wherein the said monitoring unit is arranged to identify the number of physical resource blocks in use at any one time.

18. A data transmitter as claimed in claim 11, and arranged to return to transmission at the said first power level if it is determined within the monitoring unit at the radio resource occupancy has increased above the said threshold value.

19. A data transmitter as claimed in claim 11 and including a scheduler for determining the duplication factor to be applied to the data block.

20. (canceled)

21. A data transmitter for a mobile radio communications network cell and substantially as hereinbefore described with reference to, and as illustrated in, FIG. 3 of the accompanying drawings.

22. A data transmitter for a mobile radio communications cellular network and which is arranged to transmit, at a first transmission power level, at least one data block, the transmitter including:
monitoring means for monitoring radio resource occupancy within a cell; and
duplicating means for at least duplicating the data block within the cell and responsive to a determination that the radio resource occupancy has reduced to a level below a threshold value, the transmitter being arranged to transmit the duplicated data blocks at a second transmission power level less than the first transmission power level.
